(19) United States
(12) Patent Application Publication
(10) Pub. No.: US 2007/0113443 A1
(43) Pub. Date: May 24, 2007

(54) Billboards

(76) Inventor: Jason Bregman, Melbourne (AU)

Correspondence Address: Clifford W Browning, 111 Monument Circle - Suite 3700, Indianapolis, MN, 46204-5137, US

(21) Appl. No.: 10/555,715

(22) PCT Filed: May 6, 2004
(86) PCT No.: PCT/NZ04/00085

§ 371 Date: Oct. 30, 2006

(30) Foreign Application Priority Data
May 6, 2003 (NZ) 525693

(51) Int. Cl. G09F 13/06

(52) U.S. Cl. 40/579

(57) ABSTRACT

An apparatus for displaying images includes an enclosure (11), a frame (20) installed in the enclosure (11) and adapted to hold an interlaced image (21), and an optical barrier (12) spaced from the frame (20) and adapted to obscure portions of an installed interlaced image (21).

### FIELD OF THE INVENTION

The present invention relates to billboards for displaying images and in particular to billboards for displaying images that appear to a viewer to be 3D.

### BACKGROUND OF THE INVENTION

3D, animation and flip technology is currently implemented using a lenticular lens disposed in front of an interlaced image print. U.S. Pat. No. 5,847,808 provides a general indication of the technology. The print is created using software that takes “slices” or “strips” of several images and interlaces them using an offset press or a digital printer. The print is applied directly to the back of the lenticular lens, such that the interlaced portions are aligned with the lenticles of the lens. The lenticular lens obscures a subset of the interlaced strips when viewed from a particular angle, such that a composite image is seen, comprising strips originating from one or more of the interlaced images. As the viewer angles shifts, other strips are obscured presenting another composite image to the viewer.

Where the print comprises strips from multiple images of different layers of an object, a 3D effect is achieved. In this context, 3D means the viewer perceives that the image has depth, when viewed at various angles. Flip and animation technology operates in a similar manner, wherein several interlaced sequential images are provided on the print, and the viewer sees each in sequence as they view at different angles. This produces the perception of animation—or flipping, if only two images are used. A similar affect can be produced using a barrier, instead of a lenticular lens, such as shown in U.S. Pat. No. 5,695,346 and U.S. Pat. No. 4,927,238. In this case, the black barrier lines obscure certain portions of the interlaced print at particular angles.

While existing technology can be used to display billboard sized 3D images, animations and flips, it is a relatively difficult and costly exercise due to the limitations of the technology. For example, the largest lenticular lens available is 2.5 m by 1.2 m. Therefore, to provide a billboard sized display, multiple lenses and prints must be combined.

### SUMMARY OF THE INVENTION

It is an object of the invention to provide an apparatus that can display billboard sized images that are perceived as 3D.

In one aspect the present invention comprises an apparatus for displaying images including: an enclosure, a frame installed in the enclosure and adapted to hold an interlaced image, and an optical barrier spaced from the frame and adapted to obscure portions of an installed interlaced image.

Preferably, the apparatus further includes an image installed in the frame. The image is a composition of multiple interlaced images.

Preferably, the interlaced images in conjunction with the optical barrier display 3D images to a viewer.

In one embodiment the image is applied to a single piece of translucent material.

Preferably, the optical barrier includes a plurality of elongated grills. The grills may be extruded from a non-reflective material, such as anodized aluminium. Preferably, the grills have a triangular or circular segment cross-section.

Preferably, the grills are arranged adjacently in a linear array, oriented vertically, with a gap between adjacent grills. Preferably, the grills are spaced such that there is a ratio of 80/20 of grill width to gap. Most preferably, the width of each grill is 20.32 mm wide, and the gap between each grill is 5.08 mm wide to provide viewing between the angles of 15-165°.

Preferably, the enclosure is adapted to house a light source to provide back lighting for an image installed in the frame. The light source may be a plurality of fluorescent lights, for example. Preferably the enclosure is constructed from non-reflective, opaque material.

Preferably, the space between the image frame and optical barrier is adjustable, either manually or automatically. This may be by way of a suitable mechanical or electromechanical adjustment system, such as telescopic or slidable spacers. This can alter the perceived depth of a displayed image, and/or ensure the desired optical effect is achieved by the apparatus.

Preferably, the relative horizontal and vertical position of the image frame and optical barrier is adjustable, either manually or automatically. This may be by way of a suitable mechanical or electromechanical adjustment system. This may be to align the interlaced image with the grills of the barrier, and/or ensure the desired optical effect is achieved by the apparatus.

Preferably the enclosure can be tilted to provide optimum viewing.

### BRIEF DESCRIPTION OF THE DRAWINGS

Preferred embodiments of the invention will be described with reference to the accompanying drawings, of which:

FIG. 1 shows a preferred embodiment of an assembled billboard for displaying images according to the invention,

FIG. 2 shows and exploded view of the billboard, including a image frame and optical barrier,

FIG. 3 shows a cross-sectional view of the billboard viewed from point A in FIG. 1,

FIG. 4 shows a cross-sectional view of the billboard viewed from point B in FIG. 1,

FIG. 5A shows one embodiment of the optical barrier in relation to the image in more detail,

FIG. 5B shows another embodiment of the optical barrier in relation to the image in more detail, and

FIGS. 6A-6D show an example of a interlaced image in relation to the optical barrier.

### DETAILED DESCRIPTION OF THE PREFERRED EMBODIMENTS

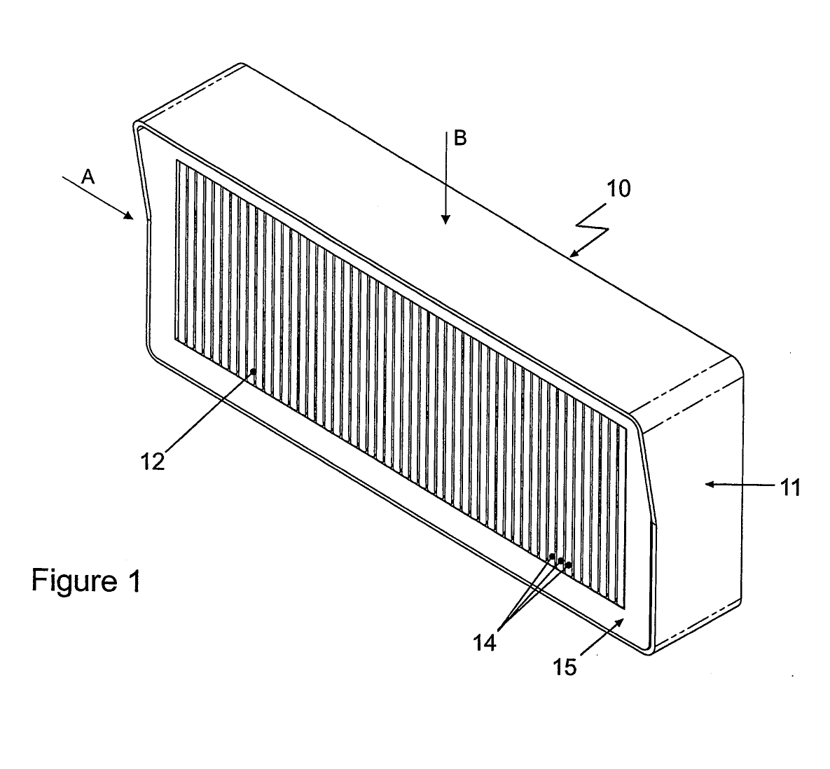

FIG. 1 shows a preferred embodiment of a billboard 10 according to the invention in assembled form. The term “billboard” is used throughout the specification to refer to a structure which displays an image. While the structure of the present invention is not a billboard in the traditional sense, it can be used to display images of a size and nature typically displayed by traditional billboards. For example, it can display images which are 6 m by 3 m or larger in size.

In the preferred embodiment, the billboard 10 is adapted to display 3D images. The billboard 10 includes an opaque enclosure 11, constructed from a base (not visible in FIG. 1) and four sides. An optical barrier 12 covers the enclosure 11. Preferably the optical barrier 12 is formed by a plurality of opaque grills, eg 14, supported in a rectangular frame 15. The image displayed by billboard 10 is viewed through optical barrier 12. The structure 10 forms a light box which substantially restricts light entering or escaping. Typical overall dimensions of a billboard are 6.5 m×3.5 m with greater sizes generally seeing a disproportionate increase in the longitudinal dimension.

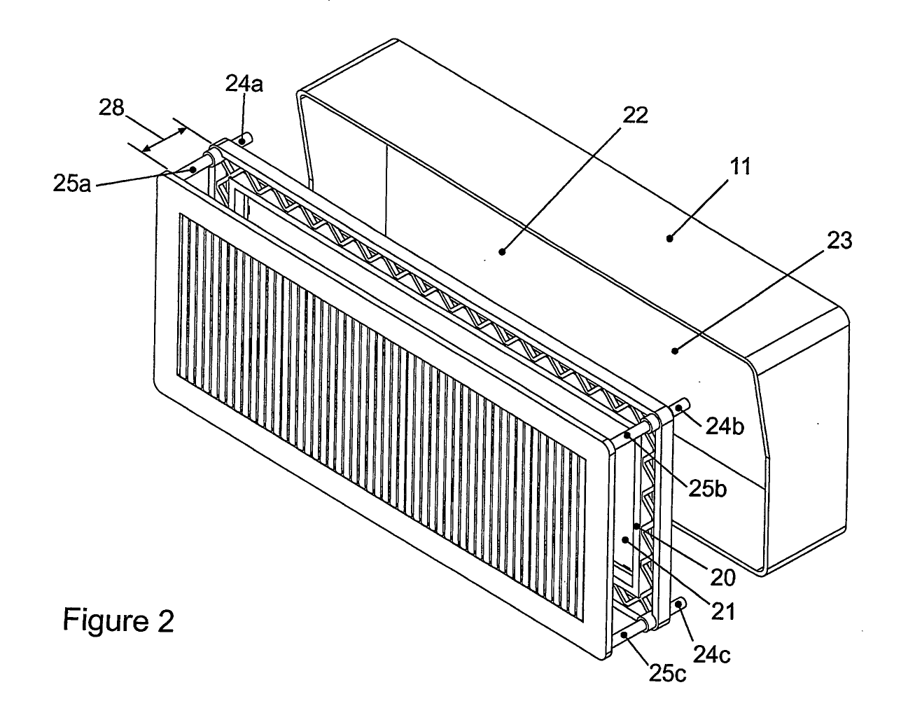

FIGS. 2 to 4 show internal components of the billboard 10. A image frame 20, adapted to hold a image 21, is disposed in the interior 22 of the enclosure 11. Preferably, the image frame is constructed of steel or similar, and has a non-reflective border with a width of approximately 10% to 20% of the length of the image 21, to enhance viewing. Alternatively different frame widths may be used. The image 21 is a composition of multiple interlaced images. In one embodiment the image is applied to a single piece of suitable light transparent or translucent image material, such as specified backlit canvas or the like. The image 21 can be stretched over and installed on the frame 20, and a mechanical tension locking system (not shown) holds the image 21 taut. The image frame 20 is spaced from the back wall 23 of the enclosure 11 by four spacer rods, of which three 24a-24c are visible in FIG. 2. The spacer rods 24a-24d are interconnected between the frame 20 and the back wall 23 of enclosure 11 by any suitable means known in the art. The optical barrier 12 is attached to and spaced 28 apart from the image frame 20, by four spacer rods, of which three, 25a-25c are visible.

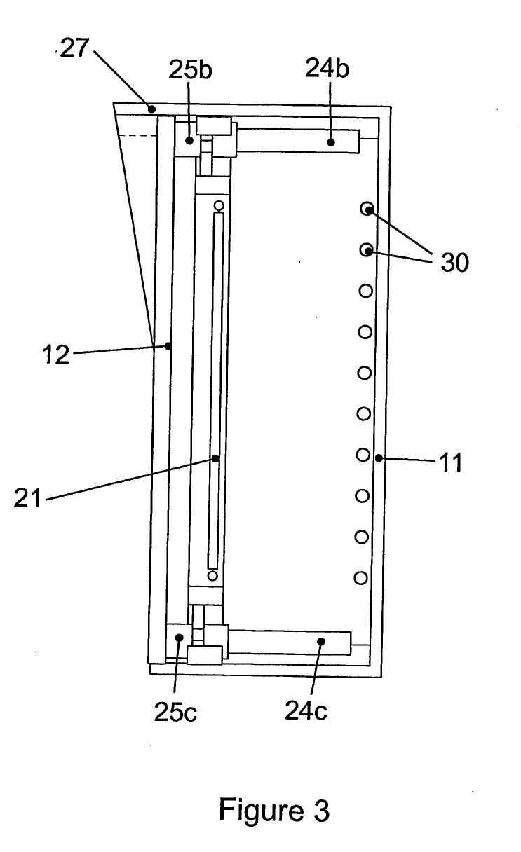

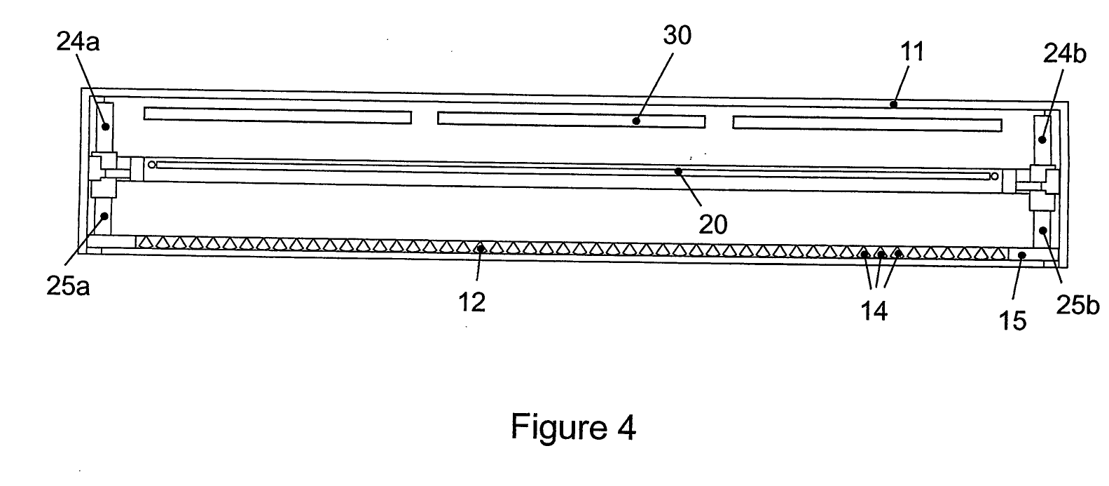

In one embodiment, the interior 23 of the enclosure 11 behind the image frame 20 houses a suitable light source (shown in FIGS. 3 and 4) to back light the image 21. The light source could be, for example, an array of fluorescent lights 30 as shown in FIGS. 3 and 4. Illuminating the image 21 in this manner, enables a printed image to be viewed through the optical barrier 12. An overhang 27 provides some shielding of the front of the enclosure from ambient light to improve viewing conditions. Preferably, the entire structure can be tilted to optimise viewing.

FIG. 3 is a side view of the billboard viewed from point A in FIG. 1. This Figure shows the spatial relationship between the grid, image and back lights in more detail. As can be seen the image 21 is spaced from grid 12 by spacers 25b and 25c. The image is also separated from the back of enclosure 11 by spacers 24b and 24c. Lights 30 are positioned between image 21 and the back of enclosure 11 to back light image 21.

FIG. 4 is a view of the billboard viewed from point B in FIG. 1. Again the alignment of the optical barrier 12, image 20 spacers 24a, b, 25a, b, and lights 30 can be seen within enclosure 11. This Figure shows that optical barrier 12 includes a plurality of grills 14 surrounded by frame 15.

In the embodiments described above the image is provided on print 21. In alternative embodiments the image may be provided on other viewing media. Such media include rear projection of the image onto a screen or an outdoor television screen. When images are displayed on these media a light box behind the screen may not be needed. These viewing media also allow the image to be easily changed. For example a billboard of the invention may be used to sequentially display a plurality of images.

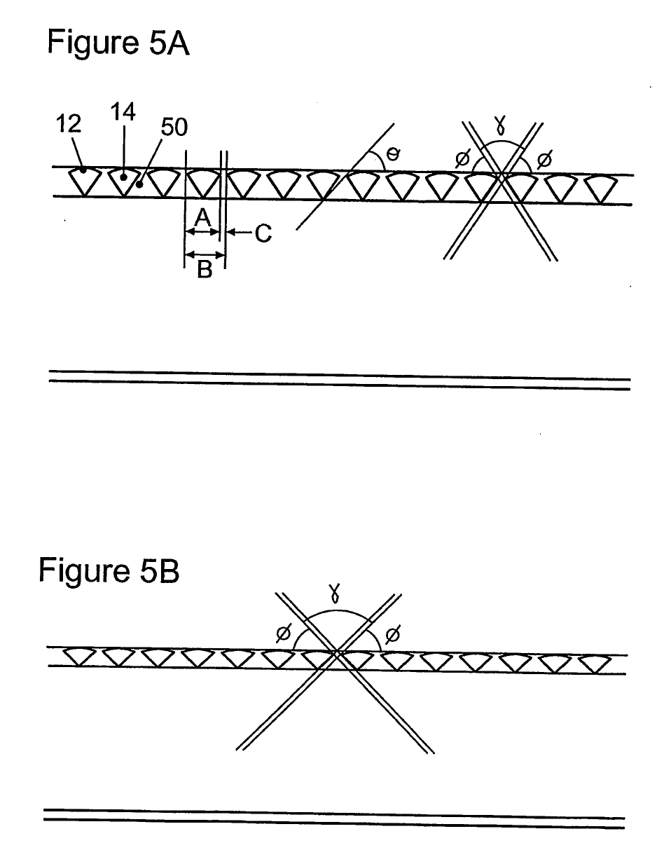

FIGS. 4 and 5A and B show a section the optical barrier 12 in further detail. In these Figures the barrier 12 includes a plurality of elongated grills, eg 14, with a triangular or circular segmented cross-section. For example, the front face of each grill is flat or curved, and the back is angled so that the vertex of the grill faces the image. The grills 14 are arranged in a linear array, each extending vertically from the top of the frame 15 to the bottom. The frame 15 is preferably non-reflective and in preferred embodiments has a width of approximately 200 mm to 300 mm to enhance the displayed image. Each grill 14 is constructed from stiff non-reflective material, such as anodized aluminium extrusion. The non-reflective qualities reduce reflection of ambient light during the day, which hampers visibility of the image 21.

In alternative embodiments the grills may be any shape that provides a changing view as a passer-by walks past the billboard. Ideally, the portion of the grills closest to the image has a smaller width than the portion of the grills closest to a passer-by. For example the grills may be a “T” shape with the top of the T closest to a passer-by and the leg of the T extending towards the image. Ideally the design of the grill will maximise the viewing angle of the image. The grill should also be designated to minimise reflection from the grill, maximise the strength of the grill, and minimise movement of the grill. Reflection from the grill can be minimised in a number of ways including by matt black coating at least any surface of the grill visible to a passer-by or by pitting at least any surface of the grill visible to a passer-by. The strength of the grill can be maximised by forming the grill from stiff material. Additional strength can be obtained by running high-tensile wires through the inside of any hollow grill pieces. Movement of the grill can be minimised by high tensile wires inside hollow grill pieces. Additionally it may be possible to run high tensile wires horizontally behind and/or through grill pieces to further prevent movement of the grill in outdoor conditions.

The adjacent grills 14 are arranged to provide a gap 50 between each pair of grills, through which portions of the image 21 can be viewed by a passer-by. Preferably, there is an 80/20 grill width to spacing 50 ratio, although a variance of up to 5% can be tolerated. In FIG. 5A this ratio is the ratio of A to C where B is the width of the grill 14 and gap 50. For example, in the preferred embodiment each grill 14 has a width of 20.23 mm and the gap 50 between each grill is 5.08 mm. As will be appreciated, other dimensions that retain the substantially 80/20 ratio of grill width to space 50 could be used.

As can be seen in FIG. 5A, the triangle rear portion of each grill 14 enables a passer by to view the image over a 150° field view. By varying the width and breadth of the grills 14 the viewing angle can be changed. For example the viewing angle γ provided by the grills of FIG. 5A is between 55° and 125° giving a complete viewing angle of 70°. In FIG. 5B the width to breadth ratio of the grill 14 has increased giving a wider viewing angle. In FIG. 5B the viewing angle γ is between 40° and 140° giving a viewing angle of 100°. In these Figures the image is obscured at view angles φ and θ. If the grills are 20.23 mm with a between grill spacing of 5.08 mm and suitable grill breadth a viewing angle of 165° can be obtained. If a passer-by is outside the viewing angle the image will be obscured by grid 12. For the best viewing performance the grill pieces 14 must remain parallel to each other and equidistant from the image 21. The grill pieces must be formed of a material that will resist movement under wind loading and other outdoor conditions.

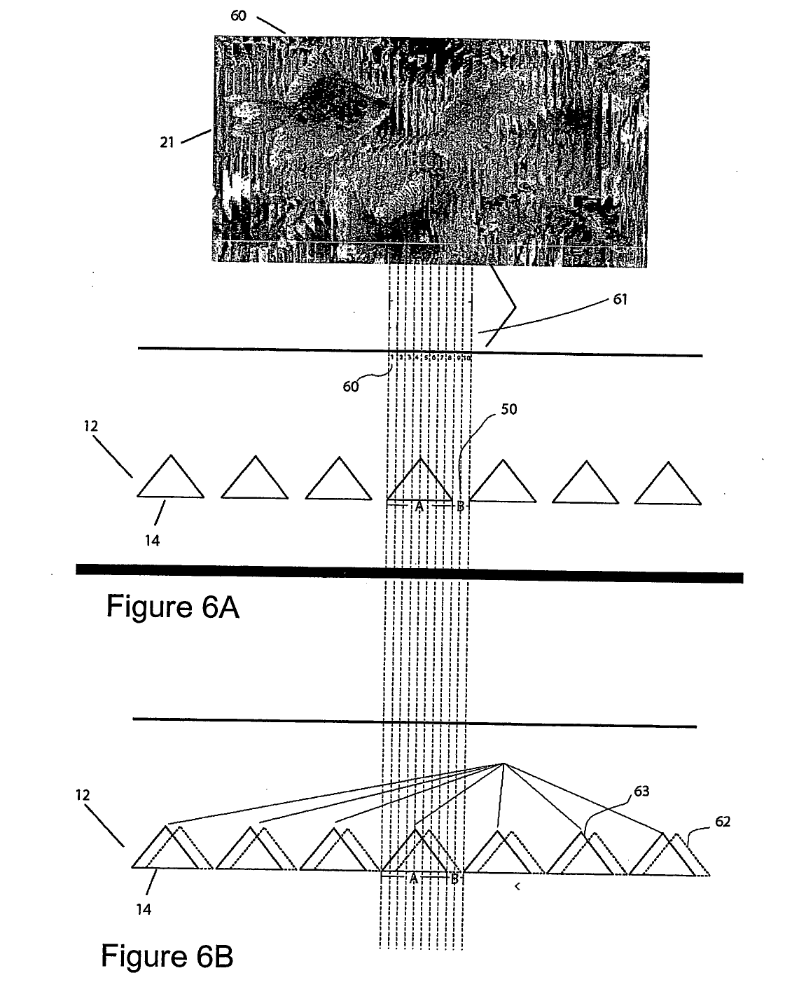

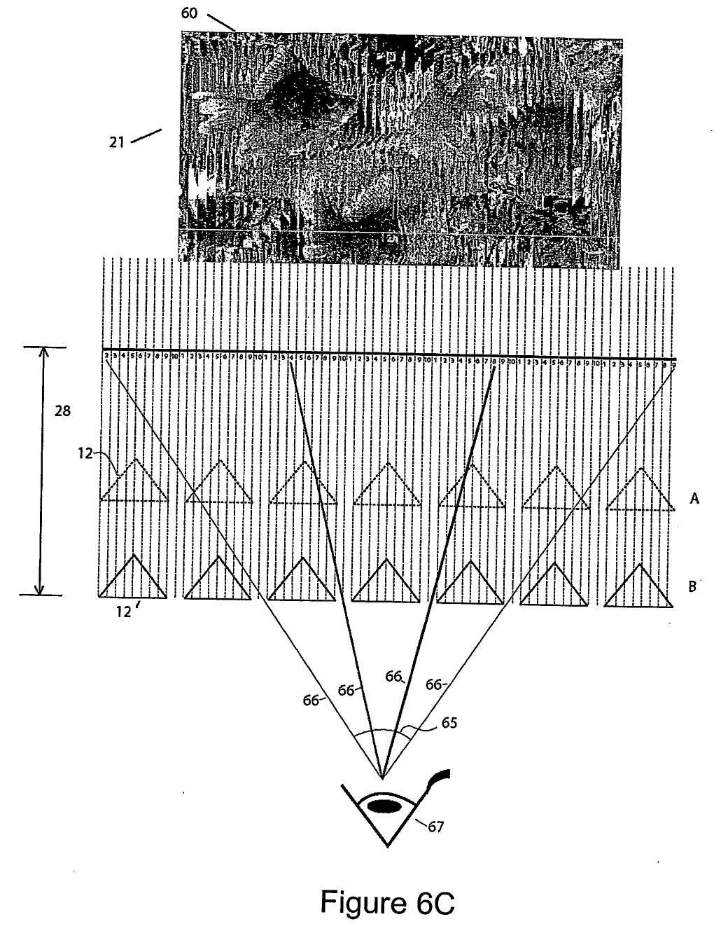

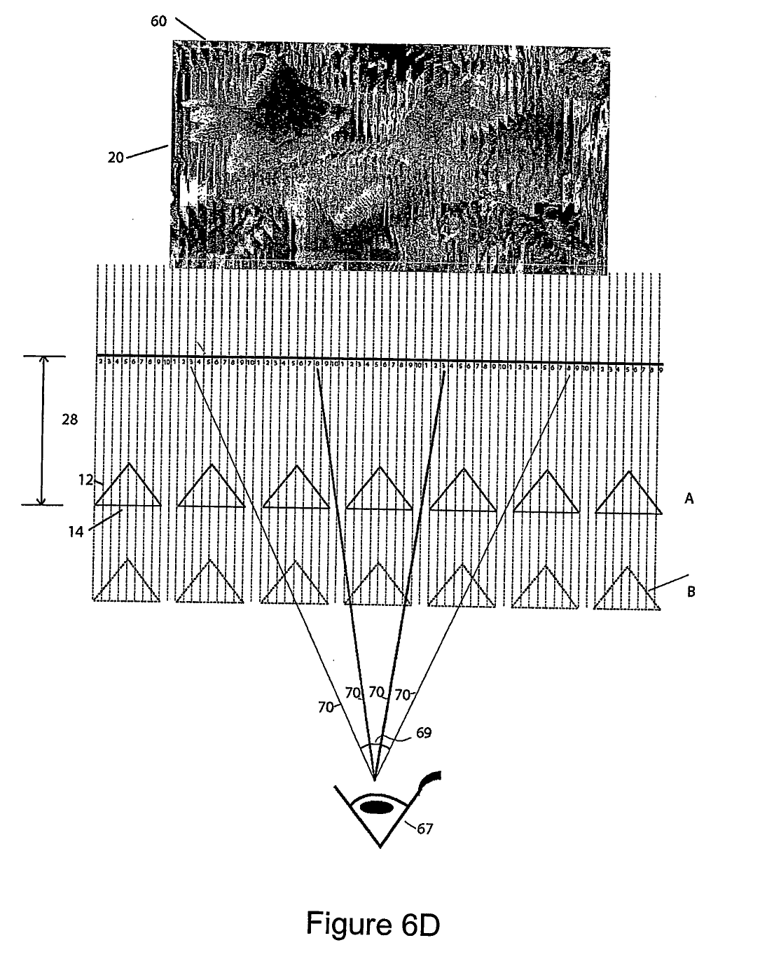

FIGS. 6A to 6D show an example of an interlaced image 21 according to the invention. The image 21 is shown in both elevation and plan to illustrate its relationship with the optical barrier 12. Each image forming the image 21 is divided into pixel strips, eg 60. The first strip from each image is arranged adjacently in the image 21, and this forms one “set”. A set may contain any number of strips but in preferred embodiments between 10 and 25 strips make up each set. The number of sets depends upon the number of grills in the billboard. For example, where ten images form the interlaced image 21, each set comprises 10 strips, one from each image. The second set is formed from the second strip of each of the 10 images, and arranged adjacently to the first set. This process is carried out for the third and subsequent sets, resulting in an entire image 21 assembled from adjacently placed sets of image slices. The forming images into strips and sets can be performed on a computer before the image is printed or otherwise displayed.

One set 61 from the image 21 can be seen in FIG. 6A. The width of the set 61 matches the width of one grill 14 plus the gap 50 to an adjacent grill. For the preferred embodiment, this width is 25.4 mm or 1 inch. Each of the 10 strips forming the set 61 have a width that is one tenth of this total, namely 2.54 mm. All the sets 61 should be aligned with corresponding grills 14. If they are not, as shown in FIG. 6b, the relative positions of the barrier 12 and image 21 should be adjusted from an unaligned position 62, to an aligned position 63.

As will be appreciated, a different number of images may form the interlaced image 21, which will result in a different number of strips forming each set 61. For example, any number between 10 and 25 images may be used in a image 21, resulting in a corresponding number of slices per set 61. In each case, the total set 61 width will match the width of a grill 14 plus gap 50, and therefore the width of individual strips must be adjusted accordingly. Where the billboard 11 displays objects in 3D, each image forming the image 21 relates to a different layer of the 3D objects. Where the billboard displays animations or flips, each image in the image 21 relates to one image in the animation/flip sequence. The interlaced image 21 could be created from individual images using interlacing software. When displaying an image in 3D the use of the different layers provided by each image give the whole image an appearance of depth thus providing the 3D effect.

Various additional features can be implemented in the basic billboard 10. The image frame 20 and optical barrier 12 could be connected by adjustable spacers 24a-24c to facilitate adjustment of the gap 28. For example, the spacer rods 24a-24c may be telescopic or slidable, such that they can manually or automatically extended or retracted to adjust the gap. Alternatively, any other suitable manual or automatic mechanical or electromechanical adjustment system could be installed. Similarly, the vertical and horizontal position of the image frame 20 and/or barrier 12 could be adjusted by a manual or electromechanical means to align the image 21 correctly with the grills 14 of the optical barrier 12. Correct alignment between the sets 61 of the image 21 and grills 14 of the optical barrier 12 is important to ensure the desired optical effect is achieved. Deliberate movement of the image 21 and/or barrier 12, can however create a desirable animation effect. Preferably, lateral movement is no greater than the width of a grill 14. For example, one option is to use an electric motor to adjust the image laterally and/or horizontally by up to 20 mm to 30 mm.

If the image is printed the image material itself may stretch somewhat when installed on the image frame 20 depending on the particular properties and composition of the image material and the anticipated ambient conditions. It may be necessary to assess this stretch in both the longitudinal and transverse directions and compensate for it, to ensure correct alignment. A mathematical stretch analysis of the image medium can be carried out, and this analysis is used when producing the image 21 to ensure stretch of the material is taken into account and the resultant interlacings are correctly proportioned within the permissible tolerances. The printing process preferably uses a higher resolution than standard billboard printing, and the amount of ink printed onto the material is doubled in density to make it light durable, and to avoid colour blowout. If the image is displayed using other media stretch analysis may not be needed.

A displayed 3D image may have an apparent depth of between 60%-100% of the billboard width, depending on the images used and background layer of the image 21. This is a perceived depth, not actual, and may differ from person to person. The perceived depth of a 3D image displayed by the billboard 10 can be changed by altering the distance 28 (shown in FIG. 6C) between the optical barrier 12 and image 21.

Altering the gap 28 also ensures the correct optical effect is achieved. The distance 28 between the frame 20 and barrier 12 is calculated to give the desired image clarity, 3D effect, and depth of image. For example, as shown in FIG. 6C, there is a wider viewing angle 65 when the gap 28 between the optical barrier 12 and image 21 is increased by moving the barrier 12 from position A to position B. This is due to the increased angles of line of sight 66 from the viewer's eye 67, through the gaps in the barrier 12, to the image 21. As a result, different subsets of the strips 60 are view, and the viewer 67 perceives a greater depth in the displayed image. As shown in FIG. 6D, if the barrier 12 is moved closer to the image 21, from position B to position A, there is a narrower viewing angle 69, due to the decreased angles of line of sight 70. Different slices of the images making up the image 21 are blocked, than in FIG. 6C. Those slices seen by the viewer form a composite image, which has a shallower depth than for the image viewed in FIG. 6C. Similarly, as the viewer moves laterally in front of the optical barrier 12, the angle of their lines of sight through the barrier 12 also changes. This results in a different subset of strips in each set being obscured by the barrier 12, causing the viewer to see a different composite image formed from the strips. In the case of a 3D image 21, the viewer will perceive that they are viewing the displayed image at different angles, when moving laterally.

Various additional features can optionally be implemented with the invention. The frame 20 can be unlocked and moved back, for example by 500 mm, to permit access to change the image 21 or conduct maintenance or the like. Components of the structure 10 are preferably constructed from materials with similar thermal expansion co-efficients to reduce uneven expansion. Doors and access ways can be included in the billboard 10 to facilitate maintenance and changing of images. Sensors to detect temperature, humidity and light remotely could be installed to monitor conditions. Drainage facilities in the billboard could be included. Additional lighting could be included in the billboard to accentuate the image and ensure adequate light distribution.

The foregoing describes the invention including preferred forms thereof. Alterations and modifications as will be obvious to those skilled in the art are intended to be incorporated in the scope hereof as defined by the accompanying claims.

1-27. (canceled)

28. An apparatus for displaying images comprising:
an enclosure,
a frame installed in the enclosure and adapted to hold an interlaced image, and
an optical barrier including a plurality of substantially parallel elongated grills spaced from the frame and adapted to obscure portions of an installed interlaced image,
and wherein the interlaced image in conjunction with the optical barrier display 3D images to a viewer.

29. An apparatus for displaying images as claimed in claim 28 further comprising a image installed in the frame.

30. An apparatus for displaying images as claimed in claim 29 wherein the image is a composition of multiple interlaced images applied to a light transparent material.

31. An apparatus for displaying images as claimed in claim 29 wherein the image is produced on a single piece of material.

32. An apparatus for displaying images as claimed in claim 28 wherein the grills may be extruded from a non-reflective material, such as anodized aluminum.

33. An apparatus for displaying images as claimed in claim 28 wherein the grills have a triangular or circular segment cross-section.

34. An apparatus for displaying images as claimed in claim 33 wherein the grills are aligned so that the smallest distance between the image and the grills is at a vertex of grills.

35. An apparatus for displaying images as claimed in claim 33 wherein the grills present a flat or curved face to a viewer.

36. An apparatus for displaying images as claimed in claim 28 wherein the grills are arranged adjacently in a linear array with a gap between adjacent grills.

37. An apparatus for displaying images as claimed in claim 36 wherein the grills are oriented vertically.

38. An apparatus for displaying images as claimed in claim 36 wherein the grills are spaced such that there is a ratio of 80/20 of grill width to gap.

39. An apparatus for displaying images as claimed in claim 36 wherein the spacing of the grill provides viewing between the angles of 15-165°.

40. An apparatus for displaying images as claimed in claim 36 wherein the width of each grill is 20.32 mm.

41. An apparatus for displaying images as claimed in claim 36 wherein the gap between each grill is 5.08 mm.

42. An apparatus for displaying images as claimed in claim 28 wherein the enclosure is adapted to house a light source to provide back lighting for a image installed in the frame.

43. An apparatus for displaying images as claimed in claim 42 wherein the light source is a plurality of fluorescent lights.

44. An apparatus for displaying images as claimed in claim 28 wherein the enclosure is constructed from non-reflective, opaque material.

45. An apparatus for displaying images as claimed in claim 28 wherein the space between the image frame and optical barrier is adjustable.

46. An apparatus for displaying images as claimed in claim 28 wherein the relative horizontal and vertical position of the image frame and optical barrier is adjustable.

47. An apparatus for displaying images as claimed in claim 28 wherein the enclosure can be tilted to provide optimum viewing.
